(19) United States
(12) Patent Application Publication
(10) Pub. No.: US 2020/0219096 A1
(43) Pub. Date: Jul. 9, 2020

(54) APPARATUS AND METHOD FOR THE CRYPTOGRAPHICALLY PROTECTED OPERATION OF A VIRTUAL MACHINE

(71) Applicant: Siemens Aktiengesellschaft, München (DE)

(72) Inventor: Rainer Falk, Poing (DE)

(21) Appl. No.: 16/632,985

(22) PCT Filed: May 7, 2018
(86) PCT No.: PCT/EP2018/061676

§ 371 Date: Jan. 22, 2020

(30) Foreign Application Priority Data
Jul. 27, 2017 (EP) 17183586.1

(51) Int. Cl. G06Q 20/40; G06F 16/23; G06F 9/455; G06Q 10/10; G06F 21/60

(52) U.S. Cl. CPC G06Q 20/401; G06F 16/2379; G06F 9/45558; G06Q 2220/00; G06F 21/602; G06F 2009/45587; G06Q 10/10

(57) ABSTRACT

Provided is a device, in particular suitable for a runtime environment for a block chain, for operating a cryptographically protected virtual machine, the device including: —at least one first link of a block chain is provided, which link includes at least one transaction data record, which describes at least one first operating state of the virtual machine and has at least one instruction for forming a second link in the block chain, the at least one transaction data record of the second link describing a second operating state of the virtual machine is modified compared to the first operating state, —checking function checks a transaction to be performed is provided and defined by the transaction data record in order to determine whether the second operating state of the virtual machine is admissible, and —carrying out the transaction depending on the checked admissibility is provided.

### CROSS-REFERENCE TO RELATED APPLICATIONS

This application claims priority to PCT Application No. PCT/EP2018/061676, having a filing date of May 7, 2018, which is based on European Application No. 17183586.1, having a filing date of Jul. 27, 2017, the entire contents both of which are hereby incorporated by reference.

### FIELD OF TECHNOLOGY

The following relates to an apparatus and a method for operating a cryptographically protected virtual machine and to an associated computer program (product).

### BACKGROUND

Hardware and software components can malfunction or be intentionally manipulated. Critical functions should be implemented reliably in this case, even if the platform used is possibly not trustworthy.

A computer system can be described in general as an automaton or machine that executes transitions. A transition can be understood in this case to mean a state transition for memories and registers as a result of the execution of a command or command sequence. The execution of a sequence of instructions or commands, also called program code, leads to a sequence of transitions. One example is a Turing machine, a register machine or a machine-programmable CPU. Such computers are not only able to be produced in hardware, they can also be implemented in software (emulation). In particular, a virtual machine can be produced by an interpreter program that executes the instructions (program code). This is known e.g. from a Java virtual machine or a Microsoft Common Language Runtime virtual machine.

In the field of safety (functional safety), “coded processing” is known, which is presented in Martin SuBkraut, Jorg Kaienburg: Safety-Critical Smart Systems with Software Coded Processing, Conference on Smart Systems Integration, Copenhagen, 2015 (see https://www.researchgate.net/publication/273351261_Safety-Critical_Smart_Systems_with_Software_Coded_Processing).

This involves calculations on a hardware platform repeatedly being performed using differently coded data. This allows safety-critical systems to be produced on a single computing system, with e.g. defects in the hardware being revealed. This avoids the hardware production complexity for multichannel computers. However, the methods known from “coded processing” provide protection only from random errors, not from intentional manipulations.

In order to detect transient errors, code replication is possible, which involves a code being executed multiple times.

### SUMMARY

An aspect relates to methods and apparatuses that provide an alternative or an improvement to the known methods.

Embodiments of the invention claim an apparatus, in particular suitable for a runtime environment for a blockchain, for operating a cryptographically protected virtual machine, having: —a device or means for providing at least one first link of a blockchain, which link comprises at least one transaction data record that describes at least one first operating state of the virtual machine and has at least one instruction to form a second link in the blockchain, wherein the at least one transaction data record of the second link describes a second operating state of the virtual machine, which second operating state has changed in comparison with the first operating state,
a device or means for providing a checking function that checks a transaction to be performed that is defined by the at least one transaction data record for whether the second operating state of the virtual machine is admissible and
a device or means for performing the transaction on the basis of the checked admissibility.

The checking function may be in particular an interpretation function for the program code of the virtual machine. The checking function (i.e. interpreter code for the VM, i.e. the interpretation function) can be put into the blockchain platform or alternatively specifically into the first blockchain transaction, which defines the initial state of the virtual machine (i.e. instantiates the virtual machine).

The checking function may be integrated in the first link in the blockchain, in particular in the first transaction data record. This means that the first transaction data record has not only the first operating state of the virtual machine but also a checking function or interpretation function for executing the program code in the virtual machine, i.e. at least one instruction for forming a second link in the blockchain. This first link of the blockchain can be any block link of a blockchain. In particular, it can be a genesis block link or one of the subsequent (block) links.

However, the checking function/interpretation function may also be arranged outside a blockchain in a runtime environment for performing the transaction. This checking function normally performs an integrity check. In information security, integrity means correctness, completeness and unmanipulated data. On the basis of this, an operating state of the virtual machine may be admissible or valid. Moreover, the checking function can undertake tasks of an interpreter, which interprets and/or executes commands for operating the virtual machine. When a transaction is performed, an operating state transition from a first to a second operating state of the virtual machine is brought about.

The checking function may be represented by what is known as a smart contract of a blockchain. This is one of multiple options for producing a cryptographically protected virtual machine.

The change of operating state can relate to machine-internal states or states of sensors, actuators and/or control devices, for devices or installations, that are arranged outside the machine.

A further aspect of embodiments of the invention is a transaction data record for a link, which may be a first link, of a blockchain, which transaction data record describes at least one first operating state of a virtual machine, having:
at least one instruction to form at least one further (second) link in the blockchain, wherein the transaction data record of the further link describes a second operating state of the virtual machine, which second operating state has changed in comparison with the first operating state, and
a checking function that checks a transaction to be performed that is defined by the transaction data record for whether the second operating state of the virtual machine is admissible.

The transaction data record is implementable as a transaction by means of a runtime environment.

The technology of blockchains (or block chains) or “distributed ledgers” is currently a technology that is the subject of intensive discussion.

A blockchain is generally understood to mean a database whose integrity (protection from subsequent manipulation) is protected by storing the one-way function value, also called the hash value, of the preceding data record or block or link in the respectively subsequent data record or block or link, that is to say through cryptographic concatenation. The protection results from a majority of trustworthy nodes in a blockchain network, which perform what are known as mining or validation of blocks. A new block is formed at regular intervals, for example every 10 minutes, in the network of nodes participating in a blockchain, and the hash value of an existing block is stored in the process. Transactions, once they have appeared in the chain, are no longer alterable unobserved. The validity of transactions to be stored in the block is checked during this mining process. Besides a mining process as “proof of work”, alternatives are also known, in particular “proof of stake”, which involves a block being confirmed by a pseudorandomly, but deterministically, selected blockchain node, or a controlled-access blockchain (permissioned blockchain).

Known blockchain systems are Bitcoin and Ethereum. Whereas Bitcoin was originally created for cryptocurrency transfers, Ethereum is based on the incorporation of what are known as smart contracts. The conditions arranged in a smart contract are protected by the blockchain, and the contract itself is handled via the network. The implementation of the contractual conditions is controlled by means of associated performed transactions. Follow-up actions provided for in a programmed smart contract can be performed according to the transaction performed. Further blockchain implementations, e.g. Hyperledger, are possible.

A blockchain-protected transaction data record generally comprises program code. The term “smart contract” is understood to mean a program code in which conditions can be defined at the time of creation and can be evaluated at the runtime of the program code, so that specific transactions at a specific (monetary) level for a specific or multiple specific recipients can be performed or otherwise.

The transaction data record can be used to perform the transaction. A transaction is understood to mean a reciprocal transfer of virtual or real goods or a payment or other information from a sender to a recipient. For Bitcoin, a relatively simple stack-based runtime environment is used. A transaction in this case comprises the checksum for checking the validity of the transaction. The blockchain platform Ethereum supports a user-programmable runtime environment, so that the program code of a blockchain can be produced flexibly. This involves e.g. a business logic being stored as program code in the transaction data record and hence in the blockchain. Viewed as such, the transaction to be performed is stored in a (chain) link of the blockchain. Accordingly, in this context, a distinction between the transaction to be performed and the transaction data record designed to perform the transaction is barely possible. The blockchain platform Hyperledger also supports a user-programmable runtime environment for performing smart contracts.

According to embodiments of the invention, a blockchain platform can be used to produce a virtual machine, which may be designed as a state machine, Turing machine, stack machine or register machine, in a manner protected from manipulation. It is possible for any conventional program to be executed in cryptographically protected fashion, or in a manner protected from manipulation, by a blockchain-based virtual machine. A virtual machine is produced by a blockchain. A state of the virtual machine is produced by a transaction of the blockchain. A smart contract of the blockchain specifies what a valid subsequent state is. The state is likewise included as a transaction in the blockchain in a subsequent block. The smart contract of the blockchain produces an interpreter for the virtual machine. The interpreter indicates what state transitions (transactions of the virtual machine) are admissible. This allows different virtual machines to be produced in a blockchain platform. It is thus e.g. also possible for processors (CPUs) available as hardware, such as e.g. 6502, Z80, ARM Cortex MO, TMS320, to be produced as a virtual machine by a smart contract of a blockchain platform. This allows program code intended for execution on a CPU to be executed in a manner protected from manipulation in a blockchain-based virtual machine. Similarly, virtual machines, such as e.g. a Java virtual machine (JVM) or a Microsoft Common Language Runtime (CLR) virtual machine, can be executed in a manner protected from manipulation in a blockchain-based virtual machine. This allows program code intended for execution on a known virtual machine to be executed in a manner protected from manipulation in a blockchain-based virtual machine.

The logic of the blockchain therefore ensures that the virtual machine is executed correctly. The blockchain can easily be produced by a multiplicity of different nodes (different hardware, different operating systems). The sequence of state transitions is transparent to outsiders and hence checkable, since the sequence of blockchain transactions is reproducible. This allows an extremely reliable computer system to be produced without needing to use special computer architectures or coded processing.

Additionally, the integrity of the execution is protected not only from random errors but also from deliberate manipulation as a result of the blockchain-based execution. Furthermore, the blockchain platform can be executed on different hardware platforms, which means that exploitation of a hardware trojan of a hardware platform is prevented or at least hampered.

A further aspect of embodiments of the invention is a method for the cryptographically protected operation of a virtual machine, having the following steps:
providing at least one first link of a blockchain, which link comprises at least one transaction data record that describes at least one first operating state of the virtual machine and has at least one instruction to form a second link in the blockchain, wherein the at least one transaction data record of the second link describes a second operating state of the virtual machine, which second operating state has changed in comparison with the first operating state,
providing a checking function that checks a transaction to be performed that is defined by the at least one transaction data record for whether the second operating state of the virtual machine is admissible, and
performing the transaction by means of an apparatus suitable for a runtime environment of the blockchain, in particular of the aforementioned type, on the basis of the checked admissibility.

The method is repeatable. Multiple links beginning with a starting link can be formed or produced, each link separately being able to contain a checking function of the aforementioned type or subfunctions thereof as appropriate. This means that the blockchain has a sequence of transactions that each have an operating state of the virtual machine. The virtual machine comprises a plurality of instructions. On the basis of the instructions of the virtual machine, a consecutive operating state is ascertained or checked. A link having a consecutive operating state of the virtual machine can be formed in each case for each instruction. It is also possible for multiple instructions to be combined to form a link having a consecutive operating state of the virtual machine. Furthermore, it is possible for the virtual machine to have a termination instruction that terminates execution of the virtual machine. The method can be developed in accordance with the developments and embodiments of the aforementioned apparatus.

The method is preferably performed in computer-aided fashion.

Unless indicated otherwise in the description below, the terms “perform”, “calculate”, “computer-aided”, “compute”, “establish”, “generate”, “configure”, “reconstruct” and the like preferably relate to actions and/or processes and/or processing steps that alter and/or produce data and/or that convert data into other data, the data being able to be presented or available as physical variables, in particular, for example as electrical impulses. In particular, the expression “computer” should be interpreted as broadly as possible in order to cover in particular all electronic devices having data processing properties. Computers can therefore be for example personal computers, servers, programmable logic controllers (PLCs), handheld computer systems, pocket PC devices, mobile radios and other communication devices that can process data in computer-aided fashion, processors and other electronic devices for data processing.

Within the context of embodiments of the invention, “computer-aided” can be understood to mean for example an implementation of the method in which in particular a processor performs at least one method step of the method.

Within the context of embodiments of the invention, a processor can be understood to mean for example a machine or an electronic circuit. A processor can be in particular a central processing unit (CPU), a microprocessor or a microcontroller, for example an application-specific integrated circuit or a digital signal processor, possibly in combination with a memory unit for storing program commands, etc. A processor can for example also be an IC (Integrated Circuit), in particular an FPGA (Field Programmable Gate Array) or an ASIC (Application-Specific Integrated Circuit), or a DSP (Digital Signal Processor) or a graphics processor GPU (Graphics Processing Unit). A processor can also be understood to mean a virtualized processor, a virtual machine or a soft CPU. It can for example also be a programmable processor that is equipped with configuration steps for performing the method according to embodiments of the invention or that is configured by means of configuration steps such that the programmable processor produces the features according to embodiments of the invention for the method, the component, the modules, the means or other aspects and/or subaspects of embodiments of the invention.

Within the context of embodiments of the invention, a “memory unit” can be understood to mean for example a memory in the form of random access memory (RAM) or a hard disk.

Within the context of embodiments of the invention, means can be understood to mean for example a processor and/or a memory unit for storing program commands. By way of example, the processor is configured specifically to execute the program commands such that the processor performs functions to implement or produce the method according to embodiments of the invention or a step of the method according to embodiments of the invention.

Within the context of embodiments of the invention, “providing” can be understood to mean for example creating, loading or storing the transaction data record on or from a data carrier or platform.

One embodiment of the invention is a block or link of a blockchain comprising one or more transaction data records. A blockchain is made up of multiple blocks.

Within the context of embodiments of the invention, “link” can be understood to mean a block of a blockchain produced in particular as a data structure.

Within the context of embodiments of the invention, “preceding links for the first link of the blockchain” can be understood to mean for example only the link of the blockchain that directly precedes the first link, in particular. Alternatively, “preceding links for the first link of the blockchain” can be understood to mean in particular also all links of the blockchain that precede the first link.

Within the context of embodiments of the invention, a “transaction data record” can be understood to mean for example the data of a transaction of a blockchain. A transaction data record can comprise for example a program code, which may be a smart contract, for example.

A further aspect of embodiments of the invention is a computer program (product) having program commands for the apparatus of the aforementioned type, which computer program (product) is configured by means of the program commands, which are suitable for operating a virtual machine in particular according to the aforementioned method and form at least one link of a blockchain, which link describes the operating state of the virtual machine, and make admissible changes of operating state of the virtual machine.

A computer program product (non-transitory computer readable storage medium having instructions, which when executed by a processor, perform actions) can form a runtime environment of the aforementioned type.

Additionally, a variant of the computer program product having program commands for configuring a creating device, for example a 3D printer, a computer system or a production machine suitable for creating processors and/or devices, is claimed, wherein . . .

The uses, apparatuses and computer programs (computer program products) may be designed in accordance with the developments/embodiments of the aforementioned method and the developments/embodiments thereof.

Furthermore, a providing apparatus for storing and/or providing the computer program product is possible. The providing apparatus is for example a data carrier that stores and/or provides the computer program product. Alternatively, and/or additionally, the providing apparatus is for example a network service, a computer system, a server system, in particular a distributed computer system, a cloud-based computer system and/or virtual computer system, which stores and/or provides the computer program product preferably in the form of a data stream.

This providing takes place for example as a download in the form of a program data block and/or command data block, preferably as a file, in particular as a download file, or as a data stream, in particular as a download data stream, of the complete computer program product. However, this providing can for example also take place as a partial download consisting of multiple parts and in particular downloaded via a peer-to-peer network or provided as a data stream. Such a computer program product is read into a system for example by using the providing apparatus in the form of the data carrier and executes the program commands, so that the method according to embodiments of the invention is executed on a computer or configures the creating device such that it creates this apparatus according to embodiments of the invention and/or the link and/or the blockchain.

### BRIEF DESCRIPTION

Some of the embodiments will be described in detail, with reference to the following figures, wherein like designations denote like members, wherein:

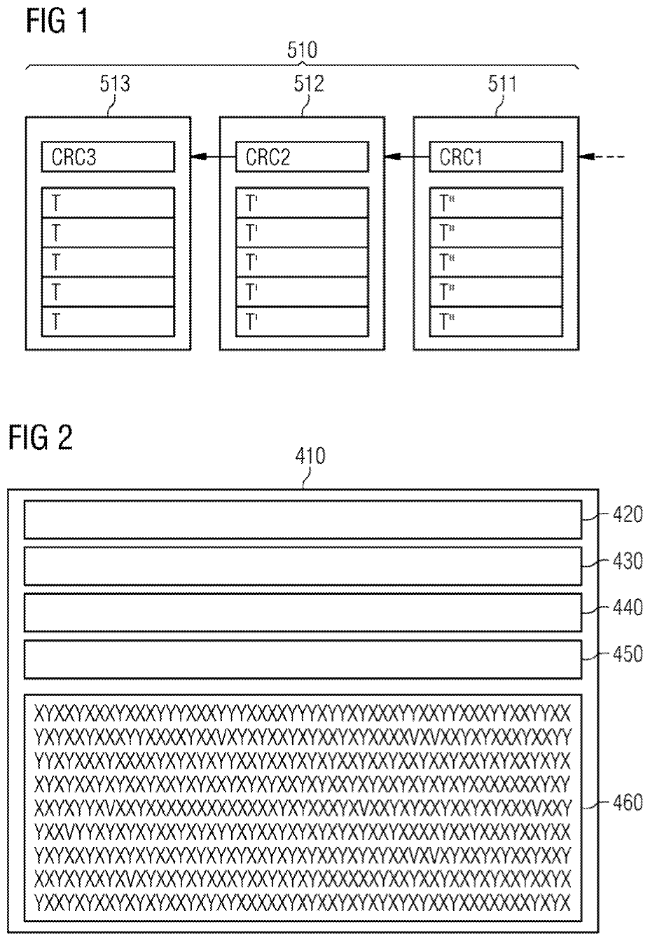

FIG. 1 shows an exemplary embodiment of the invention as a blockchain;

FIG. 2 shows an exemplary embodiment of a transaction data record of a link of a blockchain; and

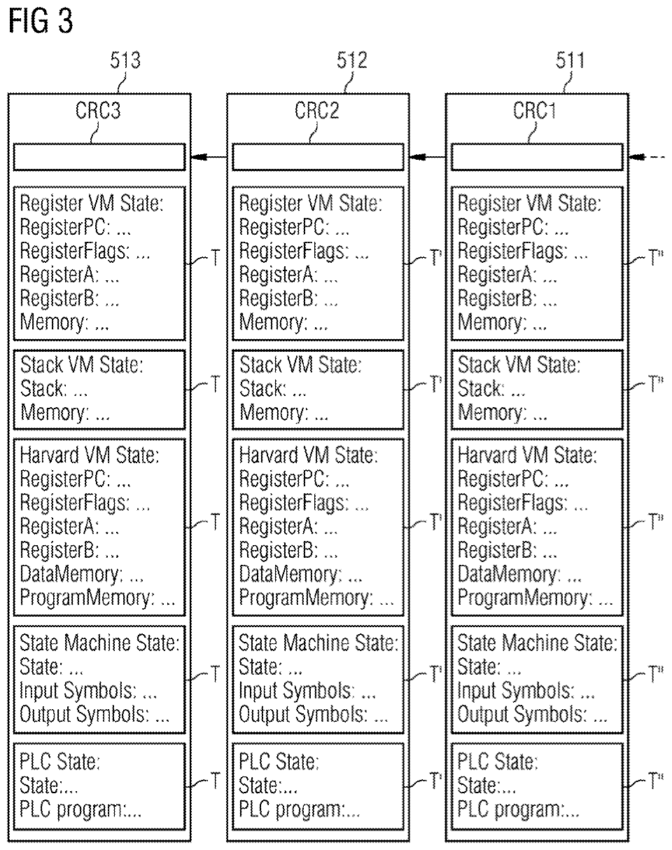

FIG. 3 shows exemplary embodiments for how a virtual machine can be configured.

### DETAILED DESCRIPTION

FIG. 1 specifically shows the links, for example a first link 511, a second link 512 and a third link 513, of a blockchain 510.

The links each comprise multiple transactions T. The links each additionally also comprise a cryptographic hash value CRC1, CRC2, CRC3, formed on the basis of the precursor link. Therefore, the first link 511 comprises a first hash value CRC1 from its precursor link, the second link 512 comprises a hash value CRC2 from the first link 511, and the third link 513 comprises a hash value CRC3 from the second link 512. The hash value may in particular be a cryptographic hash value, determinable e.g. by means of SHA2-256, SHA2-384, SHA-3, BLAKE2.

FIG. 2 shows an exemplary embodiment as a blockchain.

The transaction data record 410 can be used to perform a transaction T. The links can each comprise a hash (function) value for their transactions T, the hash (function) value being formed on the basis of the transaction data records. Usually, a hash tree, e.g. a Merkle tree or Patricia tree, is used, the root hash value of which is stored in a block or link.

A block can furthermore have a timestamp, a digital signature, a proof-of-work certificate. In this context, “proof-of-work certificate” can be understood to mean for example performance of a computationally intensive task that needs to be performed in particular on the basis of the link content/content of a transaction data record. A computationally intensive task of this kind is also referred to as a cryptographic puzzle, for example.

The program code 460 in this case is e.g. a smart contract. The transaction data record 410 can also comprise further data, such as for example a subject line 420 (e.g. Siemens SiemensABC), a public key 430 (e.g. 3A76E21876EFA03787FD629A65E9E990 . . . ), the algorithm 440 used for the public key 430 (e.g. ECC) and a parameter statement 450 pertaining to the algorithm (e.g. curve: brainpoolP160r1).

The transaction data record 410 contains a hash value (e.g. SHA256) for the smart contract 460. The smart contract is thus no longer able to be subsequently altered unobserved.

FIG. 3 shows embodiments of possible virtual machines expressed by the transaction T, T′ and T″. There are various register, memory and/or stack states for a virtual machine, the states being denoted by way of example in FIG. 3 by RegisterFlags, RegisterA, RegisterB and/or Memory, PLC program, etc. T, T′, T″ express the various states, e.g. beginning with a starting state in T, a second state in T′ and a final state in T″. The different states are reached by interpreting and/or executing one or more transaction data records of the aforementioned type 410. This involves instructions (program code) of the virtual machine being executed by a smart contract, with the smart contract in turn being executed on the blockchain runtime environment.

For the blockchain 510, there is a blockchain runtime environment, not explicitly depicted in the figures, in which the transactions T and the smart contract producing the virtual machine are interpreted or executed by means of a computer and by means of multiple computers (e.g. one computer per link 511, 512 and 513). The integrity checking function for checking or the interpretation function of the virtual machine produced by a smart contract (virtual machine interpreter smart contract) for interpreting/executing the transaction for the current state of the virtual machine and the instruction or instructions (program code) of the virtual machine is not shown explicitly in the figure. It may be integrated in the transaction data record 410 or may be arranged outside same. For the integrated approach, the integrity checking function or interpretation function may be in the form of a smart contract 460.

In this manner, a virtual machine that can be produced in the form of a register machine, stack machine or state machine can be formed in a blockchain.

A state of the virtual machine is a transaction e.g. T of the blockchain. A smart contract 460 of the blockchain specifies what an admissible or valid subsequent state is. The state is likewise included in a subsequent link as a transaction e.g. T′ in the blockchain.

A link of the blockchain confirms multiple transactions. Besides general transactions (not depicted), transactions comprising the state of a virtual machine are included according to embodiments of the invention:

As already indicated above and depicted schematically in FIG. 3, the following manifestations of the virtual machine and its (operating) states are possible:
The state of a register machine is provided by the content of the registers (program counters, flags, A, B) and of the memory. A consecutive transaction of the blockchain is valid if the machine command referenced by the program counter in the memory is presented correctly. The execution of the machine command normally leads to changed contents of the registers and of the memory.
Similarly, a stack-based virtual machine can be executed (e.g. a Forth machine). The state thereof consists of a stack and a memory.
A further virtual machine produces a Harvard architecture with separate data memory and program memory.
Additionally, a virtual machine may also be a finite-state automaton. In this case, the latter consists of the current state and a sequence of input symbols and a sequence of output symbols.
Furthermore, a virtual machine may be a programmable logic controller (PLC), which keeps the physical system state in variables. In this case, it is also possible for external information pertaining to a value ascertained by sensors to be made available as a blockchain transaction, and for at least one actuator signal for actuating physical actuators likewise to be made available as a blockchain transaction.

The logic of the blockchain therefore ensures that the virtual machine is executed correctly. The blockchain can easily be produced by a multiplicity of different nodes (different hardware, different operating systems). The sequence of state transitions is transparent to outsiders and hence checkable, since the sequence of blockchain transactions is reproducible. This allows an extremely reliable computer system to be produced without needing to use special computer architectures or coded processing.

Additionally, the integrity of the execution is protected not only from random errors but also from deliberate manipulation as a result of the blockchain-based execution. In one embodiment, a blockchain transaction is formed for each individual machine command of the virtual machine. In a further embodiment, a plurality of machine commands are executed, and the result of the plurality of executed machine commands is recorded in the blockchain as a blockchain transaction. It is e.g. possible for a new blockchain transaction to be produced after a fixed number of commands (e.g. 128). However, other criteria are also possible, in particular including criteria that are dependent on the program flow. As such, a new blockchain transaction can be produced on every jump or on every call to a subroutine (jump subroutine (JSR)) or on a return from a subroutine (return (RET)). This has the advantage that the execution speed of the virtual machine is not limited by the blockchain speed such that only a single machine command is executed for each link of the blockchain (e.g. every 20 seconds). However, it is also possible for higher-level programming languages, in particular script languages such as e.g. Python or JavaScript, or a programming language for a programmable logic controller (PLC) such as in particular Ladder (LAD), Function Block Diagram (FBD) or Instruction List (IL), to be executed by a virtual machine produced in the blockchain. Similarly, it is possible for processors (CPUs) available as hardware, such as e.g. 6502, Z80, ARM Cortex MO, TMS320, or a JVM or a CLR virtual machine also to be executed by a virtual machine produced in the blockchain.

A blockchain platform can execute a multiplicity of virtual machines in parallel, independently of one another. The blockchain platform may be public or restricted-access. In particular, it is possible to produce a secure computer based on blockchain algorithms (e.g. as a control computer or as a cloud-based control function).

Although embodiments of the invention has been illustrated and described more specifically in detail by means of the preferred exemplary embodiment, embodiments of the invention is not limited by the disclosed examples, and other variations can be derived therefrom by a person skilled in the art without departing from the scope of protection of embodiments of the invention.

The processes or method sequences described above can be implemented on the basis of instructions that are present on computer-readable storage media or in volatile computer memories (subsequently referred to as computer-readable memories in summary). By way of example, computer-readable memories are volatile memories such as caches, buffers or RAM and also nonvolatile memories such as removable data carriers, hard disks, etc.

The functions or steps described above may in this instance be available in the form of at least one set of instructions in/on a computer-readable memory. The functions or steps are not tied to one particular set of instructions or to one particular form of sets of instructions or to one particular storage medium or to one particular processor or to particular execution schemes and can be executed by software, firmware microcode, hardware, processors, integrated circuits, etc., operating on their own or in any combination. A wide variety of processing strategies can be used, for example serial processing by a single processor or multiprocessing or multitasking or parallel processing, etc.

The instructions may be stored in local memories, but it is also possible for the instructions to be stored on a remote system and to be accessed via a network.

The term “processor”, “central signal processing”, “control unit” or “data evaluation means”, as used here, comprises processing means in the broadest sense, that is to say, by way of example, servers, general purpose processors, graphics processors, digital signal processors, application-specific integrated circuits (ASICs), programmable logic circuits such as FPGAs, discrete analog or digital circuits and any combinations of these, including all other processing means known to a person skilled in the art or developed in future. Processors can consist of one or more apparatuses or devices or units. If a processor consists of multiple apparatuses, these may be designed or configured for the parallel or sequential processing or execution of instructions.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An apparatus, suitable for a runtime environment for a blockchain, for operating a cryptographically protected virtual machine, having:
device for providing at least one first link of a blockchain, which link comprises at least one transaction data record that describes at least one first operating state of the virtual machine and has at least one instruction to form a second link in the blockchain, wherein the at least one transaction data record of the second link describes a second operating state of the virtual machine, which second operating state has changed in comparison with the first operating state,
device for providing a checking function that checks a transaction to be performed that is defined by the at least one transaction data record for whether the second operating state of the virtual machine is admissible and
device for performing the transaction on the basis of the checked admissibility.

2. The apparatus as claimed in claim 1, wherein the checking function is integrated in the first link in the blockchain.

3. The apparatus as claimed in claim 1, the checking function is represented by what is known as a smart contract.

4. The apparatus as claimed in claim 1, wherein the change of operating state relates to machine-internal states.

5. The apparatus as claimed in claim 1, wherein the change of operating state relates to at least one of states of sensors, actuators and control devices, for devices or installations, that are arranged outside the machine.

6. A method for the cryptographically protected operation of a virtual machine, having the following steps:
providing at least one first link of a blockchain, which link includes at least one transaction data record that describes at least one first operating state of the virtual machine and has at least one instruction to form a second link in the blockchain, wherein the at least one transaction data record of the second link describes a second operating state of the virtual machine, which second operating state has changed in comparison with the first operating state,
providing a checking function that checks a transaction to be performed that is defined by the at least one transaction data record for whether the second operating state of the virtual machine is admissible, and
performing the transaction by an apparatus suitable for a runtime environment of the blockchain, as claimed in claim 1, on the basis of the checked admissibility.

7. The method as claimed in claim 1, wherein the checking function is provided in a manner integrated in the first link the blockchain.

8. The method as claimed in claim 1, wherein the checking function is represented by what is known as a smart contract.

9. The method as claimed in claim 1, wherein the change of operating state relates to machine-internal states.

10. The method as claimed in claim 1, wherein the change of operating state relates to at least one of states of sensors, actuators and control devices, for devices or installations, that are arranged outside the machine.

11. A transaction data record for a link of a blockchain, which transaction data record describes at least one first operating state of a virtual machine, having:
at least one instruction to form at least one further link in the blockchain, wherein the transaction data record of the further link describes a second operating state of the virtual machine, which second operating state has changed in comparison with the first operating state, and
a checking function that checks a transaction to be performed that is defined by the transaction data record for whether the second operating state of the virtual machine is admissible.

12. The apparatus as claimed in claim 1, having at least one transaction data record for a link of a blockchain, which transaction data record describes at least one first opening state of a virtual machine, having:
at least one instruction to form at least one further link in the blockchain, wherein the transaction data record of the further link describes a second operating state of the virtual machine, which second operating state has changed in comparison with the first operating state, and
a checking function that checks a transaction to be performed that is defined by the transaction data record for whether the second operating state of the virtual machine is admissible.

13. A computer program product, comprising a computer readable hardware storage device having computer readable program code stored therein, said program code executable by a processor of a computer system to implement a method having program commands for the apparatus as claimed in claim 1, which computer program product is configured by the program commands, which are suitable for operating a virtual machine as claimed in one of the preceding method claims and form at least one link of a blockchain, which link describes the operating state of the virtual machine, and make admissible changes of operating state of the virtual machine.
